(19) United States
(12) Patent Application Publication
(10) Pub. No.: US 2023/0389485 A1
(43) Pub. Date: Dec. 7, 2023

(54) METHOD AND SYSTEM FOR DEHUMIDIFYING AN ENCLOSURE

(71) Applicant: WATERGEN LTD., Petah Tiqwa (IL)

(72) Inventor: Sharon DULBERG, Beer Sheva (IL)

(73) Assignee: WATERGEN LTD., Petah Tiqwa (IL)

(21) Appl. No.: 18/234,556

(22) Filed: Aug. 16, 2023

Related U.S. Application Data
(63) Continuation of application No. PCT/IL2022/050181, filed on Feb. 15, 2022.
(60) Provisional application No. 63/149,708, filed on Feb. 16, 2021.

(51) Int. Cl. A01G 9/24; E04H 6/44

(52) U.S. Cl. CPC A01G 9/246; A01G 9/247; E04H 6/44

(57) ABSTRACT

Method and system for controlling the humidity in an enclosure that has a humidity source such as a greenhouse. The system includes a refrigeration type dehumidifier having an air-to-air heat exchanger coupled to the evaporator. Air from within the enclosure flows through the air-to-air heat exchanger before and after it comes in contact with the evaporator, and the air that is exhausted from the condenser is expelled outside the enclosure. The water that is generated from condensation of humidity of the air within the enclosure is collected and dispensed to replenish water to the humidity source for example by irrigation of plants in a greenhouse. Hygrometers may be coupled to the system to indicate when dehumidification and/or irrigation is required.

### RELATED APPLICATIONS

This application is a Continuation of PCT International Application No. PCT/IL2022/050181, International Filing Date Feb. 15, 2022, claiming priority of U.S. Provisional Patent Application No. 63/149,708, filed Feb. 16, 2021 and which is hereby incorporated by reference.

### TECHNICAL FIELD

The present invention relates to the field of dehumidifying methods and systems. More particularly, the present invention relates to dehumidifying greenhouses.

### BACKGROUND OF THE INVENTION

A dehumidifier is an apparatus which reduces and maintains the level of humidity in the air, by extracting water from the air. Generally, dehumidifiers operate according to one of two modes of operation—condensation of humidity by reducing the dew point of the air entering the dehumidifier using a refrigeration cycle or absorbing humidity from the air by using a desiccant. Large dehumidifiers that are used in commercial buildings such as indoor ice rinks and swimming pools, as well as manufacturing plants or storage warehouses and greenhouses usually belong to the first type and consume considerable energy to operate effectively.

Both refrigeration cycle and desiccant absorption-desorption cycle produces heat and if the dehumidifier is installed inside the enclosure then this heat increases the temperature within the enclosure, which might incur a heavy energetic toll if that heat is required to be expelled by using an air conditioner.

In many instances, dehumidifiers are used in enclosures which contain a source of humidity, which needs to be nourished by a supply of water in order to fulfil a certain functionality. For instance, in an ice skating rink ice evaporates which ads to humidity that is contributed from the presence of skaters. From time to time, due to ice scratched from the skate blades and due to evaporation of ice, new ice needs to be formed by spraying water which freezes on top of the ice surface. In greenhouses, water is evaporated from plants which builds up humidity in the greenhouse and these same plants need to be watered in order to grow.

There is room for improvements in the field of dehumidifiers in order to make them more energy efficient and in finding ways to utilize the water that is obtained by the process.

### SUMMARY OF THE INVENTION

The object of the invention is to provide solutions to the challenges and drawbacks of described above.

One object of the invention is to allow control of humidity in an enclosure having a humidity source and while minimizing heating the air within the enclosure.

Another object of the invention is to allow control of humidity within an enclosure in high energetic efficiency.

Another object of the invention is to replenish water which are condensed from the humidity in the enclosure back to the humidity source such as watering plants that are grown in a greenhouse a hangar or container.

Another object of the invention is to control the temperature in an enclosure together with humidity control.

In a first aspect the invention provides a method for controlling humidity in an enclosure, the enclosure comprising an air exchange with the environment and a humidifying source, the method comprising:
providing a humidity control system to the enclosure, the humidity control system comprising a dehumidifier comprising a refrigeration cycle, an air-to-air heat exchanger, and an air motivating device, a water collection means and a water disposing means;
activating the humidity control system to circulate air flow in the circulation cycle and condense humidity therefrom into water;
collecting the condensed water in the water collection means;
dispensing collected condensed water to the humidifying source
   to obtain a humidity controlled enclosure,
   wherein the humidity control system is characterized by that
the refrigeration cycle comprises a condenser communicating with air from outside the enclosure, and the evaporator comprising an air inlet and an air outlet, communicating with a first outlet of the heat exchanger and with a second inlet of the heat exchanger;
the air to air heat exchanger comprises
   a first inlet in fluid communication with air within the enclosure,
   a first outlet in fluid communication with the air inlet of the evaporator,
   a second inlet in fluid communication with the air exit of the evaporator,
   a second outlet in fluid communication with the air within the enclosure,
   the first inlet and first outlet being connected by a first pathway, the second inlet and second outlet being connected by a second pathway, the first and second pathways being in propinquity allowing heat exchange between air flowing in the first pathway and air flowing in the second pathway
the air motivating device being disposed such as to motivate humid air to flow from within the enclosure through the first inlet, the first pathway, exit from the first outlet to flow through the evaporator, then to enter as drier airflow to the second inlet, through the second pathway, exit from the second outlet back to within the enclosure to conclude a circulation cycle;
the water collection means being positioned such that it collects condensed water from the evaporator;
the water dispensing means being in fluid communication with the water collection means and the humidity source.

In some embodiments, the method described above includes providing a humidity control system having an air-to-air heat exchanger being adapted to allow counter-flow, cross-flow or semi-cross semi-counter flow heat exchange between air flowing in the first pathway from within the enclosure to the evaporator and air flowing in the second pathway from the evaporator back to within the enclosure.

In some embodiments, the method described above comprises receiving a signal by a control unit of the humidity control system from the at least one hygrometer disposed in the enclosure, the signal corresponding to a humidity level, and the control unit operating at least one of the dehumidifier and dispensing means according to said humidity level. To this end, the humidity control system further comprises at least one hygrometer disposed in the enclosure and a control unit in communication with the at least one hygrometer, the dehumidifier and the water dispensing means.

In some embodiments, the method described above further comprises activating or increasing the power of the dehumidifier in response to receiving a signal from the at least one hygrometer indicating humidity within the enclosure above a predefined threshold, and deactivating or decreasing power of the humidifier in response to receiving a signal indicating of humidity below a predefined threshold within the enclosure.

In some embodiments, the method described above further comprises dispensing condensed water to the humidifying source in response to receiving a signal indicating humidity below a predefined threshold from a hygrometer in at least one of the humidifying source and locus thereof.

In some embodiments, the method described above is for controlling humidity in a greenhouse a hangar or a container.

In some embodiments, the method further includes a step of measuring the temperature of the air within the enclosure by a thermometer and receiving said measured temperature by the control unit. In such embodiments, the control unit may be in operable communication with selectors disposed inside ducts which connect the inlet and outlet of the condenser to surrounding air and to air within the enclosure and said selectors direct incoming and exhaust air to and from the condenser either form/to within the enclosure or from/to surrounding the enclosure. If the temperature is above a predefined threshold, the control unit operates the selector to direct incoming air to the condenser from outside the enclosure and the exhaust air from the condenser to outside the enclosure, if the temperature is below a predefined threshold temperature, the control unit operates the selectors to direct air from within the enclosure to the condenser and/or exhaust air from the condenser to the within the enclosure.

In some such embodiments if the temperature within the enclosure is above a predefined threshold, the control unit activates the condenser and the valve to connect this condenser with the refrigeration cycle, and if the measured temperature within the enclosure is below a predefined threshold temperature, the control unit operates the condenser inside the enclosure and the valve to connect the condenser inside the enclose to the refrigeration cycle.

In a second aspect the invention provides a humidity control system as described above.

In some embodiments, the humidity control system comprises a first condenser to be installed outside the enclosure and a second installed inside the enclosure, and the refrigeration line includes valves which allow to choose which one to operate.

In some embodiments the humidity control system comprises ducts adapted to direct air from within the enclosure to the condenser.

In some embodiments the humidity control system comprises ducts adapted to direct exhaust air from the condenser to the enclosure.

In some embodiments the system may include a selector disposed in the ducts mentioned above adapted for directing the incoming air to the condenser either from outside the enclosure or from within the enclosure and may similarly have a selector adapted for choosing where to direct the exhaust air from the condenser—inside the enclosure or outside the enclosure.

In some embodiments, where the enclosure comprises an illumination system, the system can further include a chamber having walls made of a thermal insulating material, the chamber having measures being compatible to enclose the illumination system, and being attachable to the walls of the enclosure. In such embodiment, the system can further include evacuation means such as a vent which can be installed on a wall of the enclosure for venting the (hot) air in the illumination chamber out of the enclosure. The chamber can include at least one translucent wall or a translucent portion of a wall allowing light to pass through and illuminate the enclosure.

In some embodiments the humidity control system further includes a thermometer being coupled to the control unit, the control unit being in operable communication with the selectors disposed in the ducts mentioned above, and adapted to switch the selector to direct incoming air to the condenser either from outside the enclosure or from within the enclosure and to direct the exhaust air from the condenser—inside the enclosure or outside the enclosure according to the measured temperature as received from the thermometer.

### BRIEF DESCRIPTION OF THE DRAWINGS

The subject matter regarded as the invention is particularly pointed out and distinctly claimed

in the concluding portion of the specification. The invention, however, both as to organization and method of operation, together with objects, features, and advantages thereof, may best be understood by reference to the following detailed description when read with the accompanying drawings in which:

FIG. 1 is a flow chart depicting a method for controlling humidity in an enclosure according to an embodiment of the invention.

FIG. 2 is a flow chart depicting a method for controlling humidity in an enclosure according to an embodiment of the invention.

FIG. 3 is a flow chart depicting a method for controlling humidity in an enclosure according to an embodiment of the invention.

FIG. 4 is a block diagram of a humidity control system for executing the method of controlling humidity in an enclosure according to an embedment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

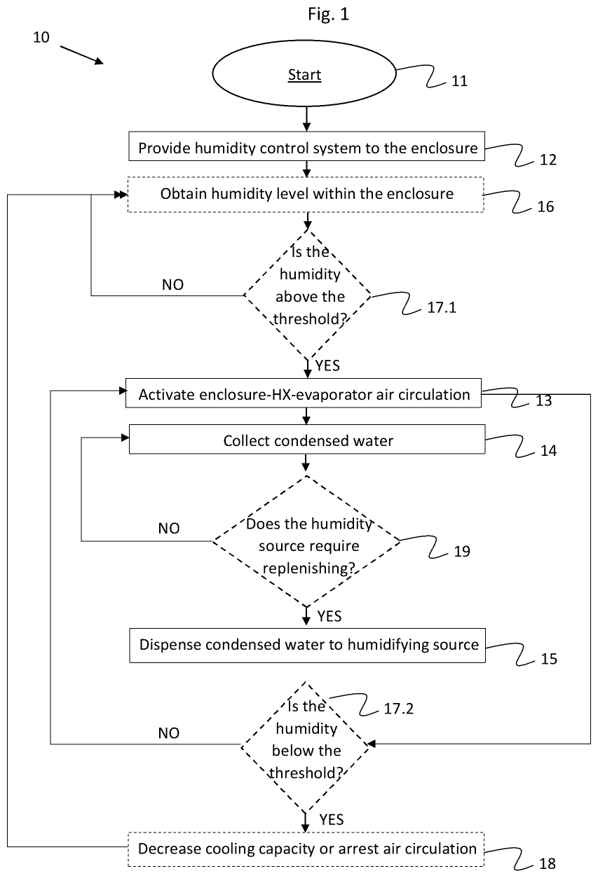

The inventor of the present invention has found that installing a refrigeration type dehumidifier such that the evaporator is in contact with air from within an enclosure and the condenser is in contact with air from outside the enclosure, the efficiency of the dehumidification process increases, and heat is evacuated and the air conditioning energy is reduced dramatically. Furthermore, adding an air-to-air heat exchanger which exchanges heat between relatively warm airflow from within the enclosure before entering the evaporator and relatively cold airflow that exits the evaporator, makes yet another contribution to the energetic efficiency. The term “relatively” is used hereinafter as a comparative term between the airflow before entering the evaporator and the airflow after exiting the evaporator. Thus, with reference to FIG. 1 in a first aspect the invention and provides a method (1000) for controlling humidity in an enclosure. The method as applied on an enclosure which has an air exchange with the environment and comprises a humidifying source (11). The enclosure can be for example a greenhouse, a hangar or a container that may exchange air with the environment surrounding the greenhouse through designated apertures in the greenhouse and the humidifying source can be the plants that grow in the greenhouse. The method comprises the following steps:
a. providing to the enclosure a humidity control system comprising a dehumidifier comprising a refrigeration cycle, an air-to-air heat exchanger, an air motivating device, water collection means and water disposing means (12);
b. activating the humidity control system to circulate air flow from within the enclosure through the air-to-air heat exchanger to an evaporator of the refrigeration cycle allowing condensation of some of the humidity in the circulating air flow, back to the air-to-air heat exchanger and back to the enclosure, (13);
c. collecting the condensed water in the water collection means (14); and
d. dispensing collected condensed water to the humidifying source (15)
   to obtain a humidity controlled enclosure.

The term “dehumidifier” refers herein to any device which is capable of converting at least some of the humidity in the air into water by condensation of water vapors into liquid. The condensation of water is achieved by reducing the temperature of a relatively humid air flow down below its dew point in a refrigeration cycle as commonly used in the art. The dehumidifier may additionally include a desiccant component that may operate in parallel or tandem with the refrigeration cycle. The refrigeration cycle includes a refrigerant line, an expansion device (such as an expansion valve), an evaporator (cold heat exchanger), a condenser (hot heat exchanger), and a compressor. Usually the humidifier includes an air motivating means such as a blower to increase the volumetric airflow passing through the evaporator. A collection means such as a water sump collects the water drops which are condensed on the evaporator and drop therefrom. The collected water can be transferred from the water sump to a water tank for storing the condensed water either with the aid of a pump or gravitationally. Various filters may also be installed—for filtering the water (sedimentation filters, carbon filters, reverse osmosis filters etc.), and for filtering the incoming air for purifying polluted air from particles and harmful chemicals. The condensed water may be treated before being dispensed by adding fertilizers, adding pesticides and sanitizing (e.g. with UV radiation). The dehumidifier also includes dispensing means for providing the stored water upon demand, which include a dispensing line and at least one faucet and may also include a human machine interface (HMI) unit showing water level, operational buttons and fault indications. The faucet may also be connected to a control unit which may have a HMI. The faucet can also be connected to and irrigation system.

The refrigeration cycle dehumidifier comprises a condenser communicating with air from outside the enclosure, and an evaporator comprising an air inlet and an air outlet, the air inlet of the evaporator communicating with a first outlet of a heat exchanger to receive relatively humid air from within the enclosure and the air outlet communicates with a second inlet of the heat exchanger to provide dryer air to within the enclosure.

The terms “dry air” and “humid air” in this article, refer to the absolute humidity ratio (ratio between the humidity mass and the dry air mass) and not to the relative humidity of the air. Relatively dry air means air having a lower absolute humidity ratio relative to an air it is compared to, and vice versa—relatively humid air means air having a higher absolute humidity ratio relative to an air it is compared to. The terms “in communication” or “communicates” mean in direct contact or in contact through a duct, a line or a conduit.

The condenser may be installed outside the enclosure in order to directly communicate and be cooled by ambient air surrounding the enclosure or it may be installed inside the enclosure and be connected to ducts which import ambient air surrounding the enclosure to chill the condenser. Similarly, the most straightforward practice is to install the evaporator inside the enclosure so it will be in fluid communication with air from within the enclosure, but it is also possible to install the evaporator outside the enclosure and have ducts lead airflow from the first outlet of the air-to-air heat exchanger to the evaporator and lead airflow which exits the evaporator to the second inlet of the air-to-air heat exchanger. In some embodiments the refrigeration comprises a barrier which separates the evaporator from the condenser such that air from within the enclosure which reaches the evaporator and is stripped off humidity does not mix with ambient from surrounding the enclosure reaching and chilling the condenser. In such embodiments having a barrier wall, the entire refrigeration cycle can be installed either inside or outside the enclosure.

The system may also include ducts which direct air from within the enclosure to the condenser and may include ducts which direct exhaust air from the condenser back to the enclosure. This can be useful when there is need to raise the temperature within the enclosure so the heat which is produced by the condenser is used to heat the air within the enclosure. In such embodiments, the system may include a selector for directing the incoming air to the condenser either from outside the enclosure or from within the enclosure and may similarly have a selector for choosing where to direct the exhaust air from the condenser—inside the enclosure or outside the enclosure. In such embodiments, the humidity control system can further include thermometer being coupled to the control unit, and the control unit can be in operable communication with the selectors disposed in the ducts and adapted to switch the selectors in response to the measured temperature as received from the thermometer.

In embodiments having a thermometer within the enclosure, the system may also have two condensers—a first condenser installed outside the enclosure and a second installed inside the enclosure, and the refrigeration line includes valves which allow to choose which one to operate. In such embodiments, the control unit can be in operable communication with the valves, and adapted to control the valves according to the temperature that is measured within the enclosure. The method of the invention is such embodiments, may also include conditional step accordingly—if the temperature is above a predefined threshold, the control unit activates the condenser and the valve to connect this condenser with the refrigeration cycle, and if the measured temperature within the enclosure is below a predefined threshold temperature, the control unit operates the condenser inside the enclosure and the valve to connect the condenser inside the enclose to the refrigeration cycle.

The air-to-air heat exchanger comprises a first inlet in fluid communication with air within the enclosure, a first outlet in fluid communication with the evaporator, a second inlet in fluid communication with air exiting the evaporator, a second outlet in fluid communication with the air within the enclosure, the first inlet and first outlet being connected by a first pathway within the heat exchanger and the second inlet and second outlet being connected by a second pathway within the heat exchanger, the first and second pathways being in propinquity allowing heat exchange between air flowing in the first pathway and air flowing in the second pathway; an air motivating device disposed such in order to motivate humid air to flow from within the enclosure through the first inlet, the first pathway, exit from the first outlet to flow through the evaporator, where a portion of its humidity is condensed, then to enter as drier, cooler, airflow to the second inlet, through the second pathway, exit from the second outlet back to within the enclosure to conclude a circulation flow. The term “in propinquity” means in proximity which allows physical interaction between the two bodies in propinquity (e.g. thermal conductivity).

It is noted that ambient air surrounding the enclosure enters the enclosure from the aperture as fresh air and mixes with the circulation flow and a portion of the circulation flow mixes with air flow that is exhausted through an aperture in the enclosure.

In some embodiments, where the enclosure comprises an illumination system, the illuminating system might generate a considerable amount of unnecessary heat. To mitigate this problem, the humidity control system can further include a chamber for separating the zone where the illuminating system is installed and replacing the (hot) air in that table with the ambient air surrounding the enclosure. The chamber may thus have walls made of a thermal insulating material, and have measures being compatible to enclose the illumination system. The chamber can be attachable to the walls of the enclosure. In such embodiment, the system can further include evacuation means such as a vent which can be installed on a wall of the enclosure for venting the (hot) air in the illumination chamber out of the enclosure. The chamber can include at least one translucent wall or a translucent portion of a wall allowing light to pass through and illuminate the enclosure. The translucence walls may be only partially translucent, allowing only the selected wavelengths of light to pass through (for example wavelengths which are applicable to growth of the plants which are grown in the enclosure.

The air-to-air heat exchanger is adapted to allow counter-flow, cross-flow or semi-cross semi-counter flow heat exchange between air flowing in the first pathway from within the enclosure to the evaporator and air flowing in the second pathway from the evaporator back to within the enclosure. To this end, the first pathway and the second pathway can share a mutual wall through which heat can exchange between the two airflows. When the air pathways are arranged parallel to each other this can allow a counter flow heat exchange, when the pathways are perpendicular to each other it obtains cross-flow heat exchange and in any angle between being perpendicular and parallel, a semi-cross semi-counter flow is obtained.

The heat is exchanged between the airflow from within the enclosure being relatively warm and the cold airflow exiting the evaporator lowers the temperature of the former and brings it closer to its dew point. This reduces the amount of energy that is required in order for bringing the airflow to its dew point in the evaporator and as a result, it saves energy, increases the amount humidity that is condensed and overall increases the efficiency of the dehumidifier.

The air motivating device is disposed such as to motivate humid air to flow from within the enclosure through the first inlet, the first pathway, exit from the first outlet to flow through the evaporator, where a portion of its humidity is condensed, then to enter as drier airflow to the second inlet, through the second pathway, exit from the second outlet back to within the enclosure to conclude a circulation cycle. The air motivating device can be a blower, a fan or any other device known to the art. The air motivating device can be placed anywhere along the airflow pathway, i.e. before the first inlet of the heat exchanger, inside the heat exchanger (i.e. in the first or second pathway), between the first outlet of the heat exchanger and the evaporator, between the evaporator and the second inlet of the heat exchanger, or after the second outlet of the heat exchanger. It is also optional to dispose several air motivating devices along the airflow pathway.

The water collection means can be positioned such that it collects condensed water from the evaporator and can be a water sump or any sort of vessel that gravitationally collects and stores the water drops which are formed in the evaporator.

Collecting the water continues as long as the air circulation is activated and humid air from within the enclosure is brought down to its dew point to shed humidity into water (14). The water that was collected is dispensed to replenish water to the humidity source at need through the water dispensing means. The dispensing of water can be used to irrigate plants that are grown in an enclosure such as a greenhouse, a hangar or a container (15).

The water disposing means is in fluid communication with the water collection means and the humidifying source. The water disposing means can include one water outlet that is connected to a supply line to the humidifying source and another outlet that is connected to pipe line leading to the sewage system or to simply evacuate the excess water or the enclosure (for example, to a water reservoir, a creek or to an outdoor irrigation system.

In some embodiments, the air-to-air heat exchanger and the evaporator can be replaced by a heat exchanger as described in International Patent Application No. PCT/IL2018/051266 or International Patent Application No. PCT/IB2014/059620 where the heat exchanger comprises a plates heat exchanger having two sets of interlayered inlets and outlets coupled to a fins and tubes heat exchanger functioning as the evaporator.

In some embodiments, the humidity control system further comprises at least one hygrometer disposed in the enclosure and a control unit in operable communication with the at least one hygrometer, the dehumidifier, and the water disposing means. In such embodiments, the method further comprises receiving a signal by the control unit from the at least one hygrometer (16), for example, a hygrometer that measures the humidity of the air within the enclosure. The signal received by the control unit from the hygrometer corresponds to the humidity level within the enclosure. The control unit is adapted to analyze the level of humidity and respond to it by providing operative instructions to the dehumidifier and/or the water dispensing means accordingly (17.1). For example, the level of humidity can be above a threshold level indicative of a need to reduce humidity in the enclosure, below a threshold indicative of a need to reduce the power level of dehumidification or below a level indicative of a need to reduce power or arrest the dehumidification process.

The method may include activating the dehumidifier (or proportionally increase the cooling capacity of the evaporator) in response to receiving a signal from the at least one hygrometer indicating humidity within the enclosure above a predefined threshold, and deactivating (or proportionally decrease the cooling capacity of the evaporator) the humidifier in response to receiving a signal indicating of humidity below a predefined threshold within the enclosure (17.2). Once the air flow is circulated from within the enclosure to the evaporator through the air-to-air heat exchanger and a measurement is obtained by the control system from the hygrometer that the air within the enclosure contains humidity below a predefined threshold then the control unit may reduce the cooling capacity of the evaporator or if reaching a predefined low humidity threshold—arrest the aforementioned air circulation (18). If it is not below the threshold, then the air circulation continues (13).

The method may include dispensing condensed water to the humidifying source in response to receiving a signal indicating humidity below a predefined threshold from a hygrometer in at least one of the humidifying source and locus thereof (19).

For example, the enclosure can be a greenhouse, and the humidity control system is installed in the greenhouse. A hygrometer may be placed in the soil in the vicinity of a plant that is grown in the greenhouse, or a set of hygrometers are placed in the soil at several locations, and in response to a signal indicating that the soil is below a predefined level of humidity for predefined period of time the control unit activates the dispensing means to supply water to the irrigation system to which it is connected (15).

In another example, the enclosure is an indoor ice skating rink, and the sensor is an ice level sensor. When the control system receives indication the ice level is below a predefined threshold, the control unit can operate the dispensing means to supply water to a spraying system for spraying water on the ice rink surface in order to elevate the ice level.

The term “operable communication” means that the control unit is in capacity to deliver instruction to activate or deactivate the components which it is in communication with according to encoded instructions on a processor. To this end the control unit contains the necessary modules in order to execute the operation of the components of the system.

The term “control unit” is inferred herein as a device comprising processing and/or computing capabilities such as a computer, network device or computer-like device which may be used for interacting with other components of the system such as the hygrometer, thermometer, refrigeration cycle components, valves and selectors in the system and may be selected from a processor, a personal computer, a server, a wireless device such as a cellular phone, a laptop, smartphone, a tablet, a smartwatch and a minicomputer.

The control unit may include an input/output interface configured to mediate data input and output between various components of the humidity control system and within the control unit, a memory configured to store executable instructions (software) and data, a graphic processor to perform image processing, a main processor configured to perform computing operations in accordance with the programs and data stored in the memory and a system bus serving as a path for transmission and reception of data among the input/output interface, the memory and the main processor.

The input/output interface may receive measurements from a hygrometer and/or a thermometer and transmit the received measurements to the main processor, or the memory via the system bus.

In addition, the input/output interface may transmit various control signals output from the main processor to the other components of the humidity control system.

The memory may retrieve control programs and control data for controlling the operation of the humidity control system.

The memory may include volatile memory such as static random-access memory (SRAM) and dynamic random-access memory (DRAM). If required, the memory may also include non-volatile memory such as flash memory, read only memory (ROM), erasable programmable read only memory (EPROM), and electrically erasable programmable read only memory (EEPROM).

The main processor may perform computing operations to process signals received from the hygrometer(s) and thermometer(s) and operate the components of the humidity control system according to predefined values and thresholds, in accordance with programs and data stored in the memory.

The computerized device is adapted by installing encoded instructions thereto to execute the method steps described herein.

In some embodiments, the water sump may contain a volume or float sensor adapted to measure the amount of water in the sump.

In some embodiments, the control unit may be connected to a user interface to accept dispensing command (e.g. an active irrigation button) or in order to display water level.

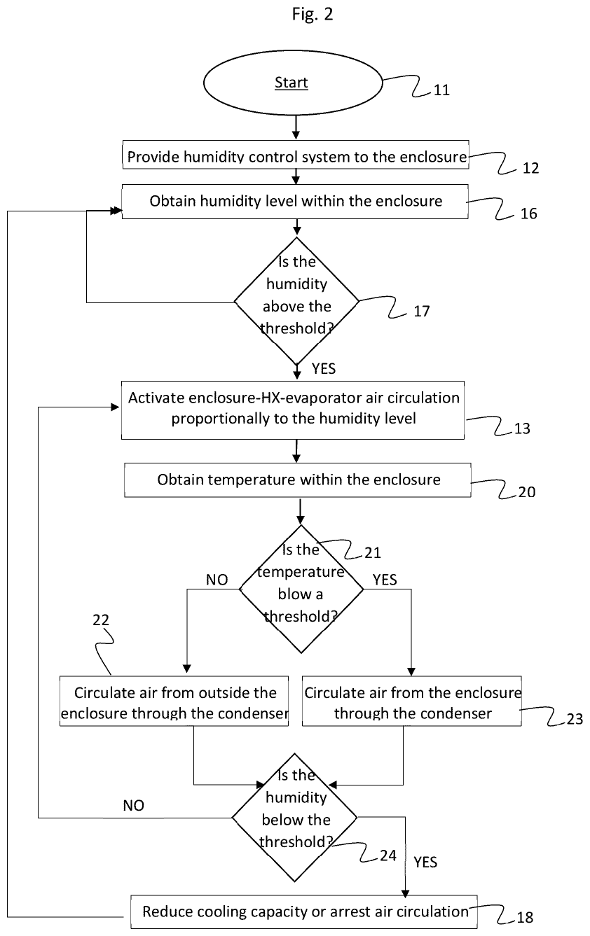

Reference is now made to FIG. 2 depicting a flow chart of the method in embodiments where the humidity control system being adapted to control the temperature of the air within the enclosure by measuring the temperature of the air with the enclosure, having ducts and selectors which allow selecting between circulating air within the enclosure or circulating air from outside the enclosure with the condenser. The method of invention is such embodiments, after obtaining the temperature of the air within the enclosure (20) may also include conditional step accordingly (21)—if the temperature is above a predefined threshold, the control unit operates the selector to direct incoming air to the condenser from outside the enclosure (22) and the exhaust air from the condenser to outside the enclosure, if the temperature is below a predefined threshold temperature, the control unit operates the selectors to direct air from within the enclosure to the condenser and/or exhaust air from the condenser to the within the enclosure (23).

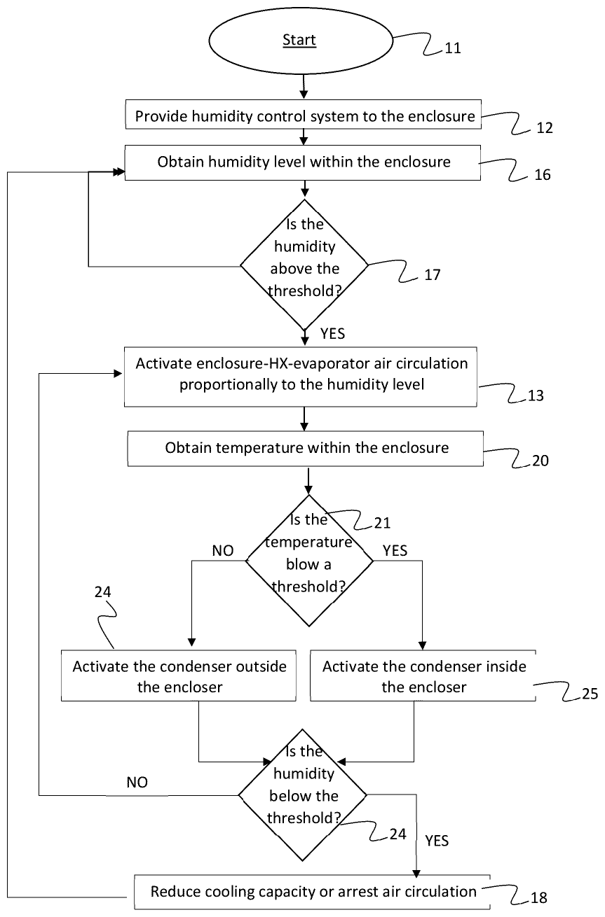

Reference is now made to FIG. 3 depicting a flow chart of the method in embodiments where the humidity control system being adapted to control the temperature of the air within the enclosure by measuring the temperature of the air with the enclosure, and having a first condenser installed inside the enclosure and a second condenser installed outside the enclosure and a refrigeration cycle including valves which allowing selectively connecting each condenser to the refrigeration cycle. In some embodiments only one of the condensers can be connected to the refrigeration cycle and in some embodiments one or both of the condensers can be connected to the refrigeration cycle. The method of invention is such embodiments, after obtaining the temperature of the air within the enclosure (20) may also include conditional step accordingly (21)—if the temperature is above a predefined threshold, the control unit activates the valves in the refrigeration cycle to connect the condenser installed outside the enclosure to the refrigeration cycle, and activates the condenser installed outside the enclosure (24). If the temperature is below a predefined threshold temperature, the control unit activates valves of the refrigeration cycle to connect the condenser installed inside the enclosure to the refrigeration cycle, and activates the condenser installed inside the enclosure (25).

During the operation of the humidity control system heat evacuated by the dehumidifier from the enclosure is regained from the environment (e.g. solar energy). The system may further control the temperature and exhaust heat out from the enclosure too.

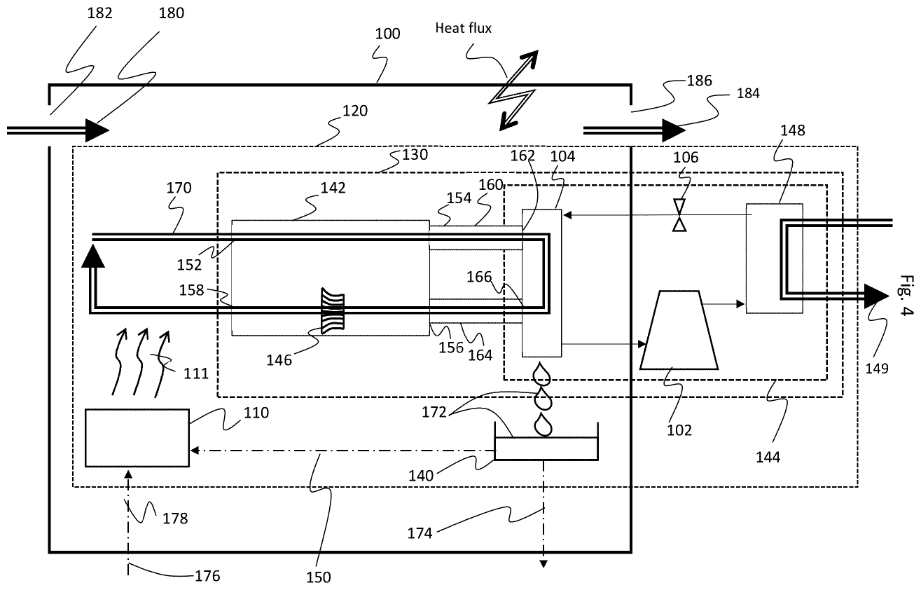

Reference is now made to FIG. 4 depicting a humidity control system according to an embodiment of the invention that is installed in an enclosure upon which the method of the invention is implemented. An enclosure 100 comprises a humidifying source 110. the enclosure 100 is installed with a humidity control system 120 which includes a humidifier 130, a water sump 140, a water dispensing component 150. The humidifier includes an air-to-air heat exchanger 142, a refrigeration cycle 144 and a blower 146. The refrigeration cycle includes the well familiar components of a condenser 148, a compressor 102, an evaporator 104, an expansion valve 106 and a refrigeration line 108 that connects them into a cycle. The condenser 148, the compressor 102, and the expansion valve 106 are located outside the enclosure 100, while the evaporator 104 is installed inside the enclosure. Ambient air flow 149 cools the condenser 148. The air-to-air heat exchanger 142 is positioned inside the enclosure and in proximity to the evaporator 104, and has a first inlet 152, a first outlet 154, a second inlet 156 and second outlet 158. Duct 160 connects the first outlet 154 to the entry 162 of the evaporator 104, and duct 164 connects the outlet 166 of the evaporator 104 to the second inlet 156 of the heat exchanger 142. An airflow 170 form within the enclosure 100 circulates through the heat exchanger 142 and the evaporator 104, then back to the heat exchanger 142 and back to the enclosure 100 as will be now described. Airflow 170 enters the air-to-air heat exchanger 104 through the first inlet 152 then it passes the first pathway (not seen) of the air-to-air heat exchanger, exits the first outlet 154, flows through duct 160, enters the evaporator 104 through entry 162 where it is cooled down to its dew point and is stripped off at least some of its humidity. The condensed water 172 drops from the evaporator to the water sump 140. The relatively cold and dry air (as compared to the airflow before it entered the evaporator 104) exits the evaporator 104 through outlet 166, and flows through duct 164 then though second entry 156 of the air-to-air heat exchanger 142, through second pathway (not shown) where it exchanges heat with the airflow passing through the first pathway. The airflow then exits the air-to-air heat exchanger 142 through the second outlet 158 back to within the enclosure 100. Water condensate 172 from the water sump 140 is disposed by the disposal conduit 150 to the humidity source 110 (e.g. the plants that are grown in a greenhouse), which provides humidity 111 to within the enclosure 100. Excess water can be disposed outside the enclosure through a water outlet 174 for example, to the sewage. The humidity source can be nourished with water not only from the water 172 that is generated by the dehumidifier 130 but also from an external source 176 through water inlet 178. Atmospheric air 180 can enter the enclosure 100 through an air inlet 182 of the enclosure 100 and air from within the enclosure 184 can exit the enclosure 100 through an outlet 186 of the enclosure.

What is claimed is:

1. A humidity control system comprising a dehumidifier, a water collection means and water dispensing means, the dehumidifier comprising a refrigeration cycle, an air-to-air heat exchanger, and an air motivating device;
the refrigeration cycle comprises a condenser communicating with air from outside an enclosure, and the evaporator comprising an air inlet and an air outlet, communicating with a first outlet of the heat exchanger and with a second inlet of the heat exchanger;
the air to air heat exchanger comprises
a first inlet in fluid communication with air within the enclosure,
a first outlet in fluid communication with the air inlet of the evaporator,
a second inlet in fluid communication with the air exit of the evaporator,
a second outlet in fluid communication with the air within the enclosure,
the first inlet and first outlet being connected by a first pathway and the second inlet and second outlet being connected by a second pathway, the first and second pathways being in propinquity allowing heat exchange between air flowing in the first pathway and air flowing in the second pathway;
the air motivating device being disposed such as to motivate humid air to flow from within the enclosure through the first inlet, the first pathway, exit from the first outlet to flow through the evaporator, then to enter as drier airflow to the second inlet, through the second pathway, exit from the second outlet back to within the enclosure to conclude a circulation cycle;
the water collection means being positioned such that it collects condensed water from the evaporator;
the water dispensing means being in fluid communication with the water collection means and a humidity source within the enclosure.

2. The humidity control system according to claim 1 comprising at least one thermometer in communication with the control unit.

3. The humidity control system according to claim 1 comprising a first condenser and a second condenser and the refrigeration line comprises valves allowing to choose which condenser to operate.

4. The humidity control system according to claim 3 wherein the control unit being adapted to activate the condenser installed inside the enclosure and the valves to connect said condenser to the refrigeration cycle if the measured temperature is below a predefined value and being adapted to activate the condenser installed outside the enclosure and the valves to connect said outside condenser to the refrigeration cycle if the measured temperature is above a predefined value.

5. The humidity control system according to claim 1 comprising ducts adapted to direct air from within the enclosure to the condenser.

6. The humidity control system according to claim 1 comprising ducts adapted to direct air exhaust air from the condenser to the enclosure.

7. The humidity control system according to claim 5 comprising at least one of (i) a selector disposed in the ducts adapted for directing the incoming air to the condenser either from outside the enclosure or from within the enclosure and (ii) a selector disposed in the ducts adapted for directing the exhaust air from the condenser to inside the enclosure or outside the enclosure.

8. The humidity control according to claim 5 wherein the control unit being adapted to receive a measured temperature from the at least one thermometer and operate the selectors to circulate air from within the enclosure through the condenser if the measured temperature is below a predefined threshold or circulate air from outside the enclosure through the condenser if the measured temperature is above a predefined threshold.

9. The humidity control system according to claim 1 further comprising at least one hygrometer adapted to be disposed in the enclosure and a control unit in communication with the at least one hygrometer, the dehumidifier and the water dispensing means; the control unit being adapted to receiving a signal from the at least one hygrometer corresponding to a humidity level within the enclosure and operating at least one of the dehumidifier and dispensing means according to said humidity level.

10. The humidity control system according to claim 1 further comprising an illuminating system separating chamber comprising thermal insulating walls, a translucent wall or portion of a wall being translucent to selected wavelengths of an illuminating system of the enclosure, and air replacement means.

11. Method for controlling humidity in an enclosure, the enclosure comprising an air exchange with the environment and a humidifying source, the method comprising:
providing a humidity control system to the enclosure, the humidity control system comprising a dehumidifier, a water collection means and a water dispensing means, the dehumidifier comprising a refrigeration cycle, an air-to-air heat exchanger, and an air motivating device;
activating the humidity control system to circulate air flow in the circulation cycle and condense humidity therefrom into water;
collecting the condensed water in the water collection means; and
dispensing collected condensed water to the humidifying source to obtain a humidity controlled enclosure,
wherein the humidity control system is characterized by that
the refrigeration cycle comprises a condenser communicating with air from outside the enclosure, and an evaporator comprising an air inlet and an air outlet, communicating with a first outlet of the heat exchanger and with a second inlet of the heat exchanger;
the air to air heat exchanger comprises
a first inlet in fluid communication with air within the enclosure,
a first outlet in fluid communication with the air inlet of the evaporator,
a second inlet in fluid communication with the air exit of the evaporator,
a second outlet in fluid communication with the air within the enclosure,
the first inlet and first outlet being connected by a first pathway and the second inlet and second outlet being connected by a second pathway, the first and second pathways being in propinquity allowing heat exchange between air flowing in the first pathway and air flowing in the second pathway;
the air motivating device being disposed such as to motivate humid air to flow from within the enclosure through the first inlet, the first pathway, exit from the first outlet to flow through the evaporator, then to enter as drier airflow to the second inlet, through the second pathway, exit from the second outlet back to within the enclosure to conclude a circulation cycle;
the water collection means being positioned such that it collects condensed water from the evaporator;
the water dispensing means being in fluid communication with the water collection means and the humidity source.

12. The method according to claim 11 wherein said air-to-air heat exchanger being adapted to allow counter-flow, cross-flow or semi-cross semi-counter flow heat exchange between air flowing in the first pathway from within the enclosure to the evaporator and air flowing in the second pathway from the evaporator back to within the enclosure.

13. The method according to claim 11 wherein the humidity control system further comprising at least one hygrometer disposed in the enclosure and a control unit in communication with the at least one hygrometer, the dehumidifier and the water dispensing means; and wherein the method further comprising receiving a signal by the control unit from the at least one hygrometer corresponding to a humidity level and operating at least one of the dehumidifier and dispensing means according to said humidity level.

14. The method according to claim 13 further comprising activating or increasing the cooling capacity of the evaporator in response to receiving a signal from the at least one hygrometer indicating humidity within the enclosure above a predefined threshold, and deactivating or decreasing the cooling capacity of the evaporator in response to receiving a signal indicating of humidity below a predefined threshold within the enclosure.

15. The method according to claim 13 further comprising dispensing condensed water to the humidifying source in response to receiving a signal indicating humidity below a predefined threshold from a hygrometer in at least one of the humidifying source and locus thereof.

16. The method according to claim 11 wherein said enclosure is a greenhouse, a hangar or a container.
